(19) United States
(12) Patent Application Publication
(10) Pub. No.: US 2016/0012104 A1
(43) Pub. Date: Jan. 14, 2016

(54) SEARCH INTERFACES WITH PRELOADED SUGGESTED SEARCH QUERIES

(71) Applicant: Yahoo!, Inc., Sunnyvale, CA (US)

(72) Inventor: Tsvetomir Petrov, Redwood City, CA (US)

(21) Appl. No.: 14/329,154

(22) Filed: Jul. 11, 2014

(51) Int. Cl. G06F 17/30

(52) U.S. Cl. CPC G06F 17/30395; G06F 17/30864

(57) ABSTRACT

Many types of devices present a search interface to a user, such as a search textbox where the user may enter text indicating a search query, and then present search results to the user. Such search interfaces are often driven by the user, and prior to selection or the entry of a user-initiated search query, are empty and available for data entry. The present disclosure involves preloading the search interface with a suggested search query that is of interest to the user before receiving a user-initiated search query, which may facilitate the user in identifying search queries that present additional interesting content. The suggested search query may relate to content presented concurrently with the search page, such as a topic presented in an article of a website adjacent to the search interface. An embodiment may also preload the search results to respond more expediently to the suggested search query.

### BACKGROUND

Within the field of computing, many scenarios involve the presentation by a device of a search interface that may enable a user to search for items of interest. When a user selects the search interface and enters a user-initiated search query (e.g., through a text interface or a speech interface), the device submits the search query to a search engine; receives a set of search results that respectively describe a content item; and presents the search results to the user. A selection of a search result causes the device to present the content item associated with the search result.

### SUMMARY

In accordance with the present disclosure includes, a device may, before receiving a user-initiated search query from the user, identify a suggested search query that is of predicted interest to the user, and present to the user the search interface preloaded with the suggested search query. The device may also, upon receiving from the user a selection of the suggested search query, present search results of the suggested search query to the user; and upon receiving the user-initiated search query from the user, present search results of the user-initiated search query to the user.

### DESCRIPTION OF THE DRAWINGS

While the techniques presented herein may be embodied in alternative forms, the particular embodiments shown in the drawings are only a few such examples that are supplemental of the description provided herein. These embodiments are not to be interpreted as limiting any aspect of the invention, which is defined by the claims appended hereto.

FIG. 1 is an illustration of a scenario involving various examples of networks that may connect servers and clients.

FIG. 2 is an illustration of a scenario involving an exemplary configuration of a server that may utilize at least a portion of the techniques presented herein.

FIG. 3 is an illustration of a scenario involving an exemplary configuration of a client that may utilize at least a portion of the techniques presented herein.

FIG. 4 is an illustration of a scenario involving an exemplary search service that may utilize at least a portion of the techniques presented herein.

FIG. 5 is an illustration of a scenario featuring an exemplary interaction of a user with a search service.

FIG. 6 is an illustration of a scenario featuring an exemplary interaction of a user with a search service in accordance with the techniques presented herein.

FIG. 7 is an illustration of a scenario featuring an exemplary method of presenting a search interface to a user in accordance with the techniques presented herein.

FIG. 8 is an illustration of a scenario featuring an exemplary server that presents a search interface to a user in accordance with the techniques presented herein.

FIG. 9 is an illustration of a scenario featuring an exemplary nontransitory memory device that causes a device to present a search interface to a user in accordance with the techniques presented herein.

FIG. 10 is an illustration of a first scenario featuring a presentation of suggested search queries of predicted interest to the user in accordance with the techniques presented herein.

FIG. 11 is an illustration of a second scenario featuring a presentation of suggested search queries of predicted interest to the user in accordance with the techniques presented herein.

FIG. 12 is an illustration of a third scenario featuring a presentation of suggested search queries of predicted interest to the user in accordance with the techniques presented herein.

FIG. 13 is an illustration of a fourth scenario featuring a presentation of suggested search queries of predicted interest to the user in accordance with the techniques presented herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and systems. Accordingly, this subject matter is not intended to be construed as limited to any example embodiments set forth herein; example embodiments are provided merely to be illustrative. Such embodiments may, for example, take the form of hardware, software, firmware or any combination thereof (other than software per se). A reasonably broad scope for claimed or covered subject matter is intended.

### 1. COMPUTING SCENARIO

The following disclosure provides a discussion of some types of computing scenarios in which the presently disclosed techniques may be utilized.

1.1. Networking

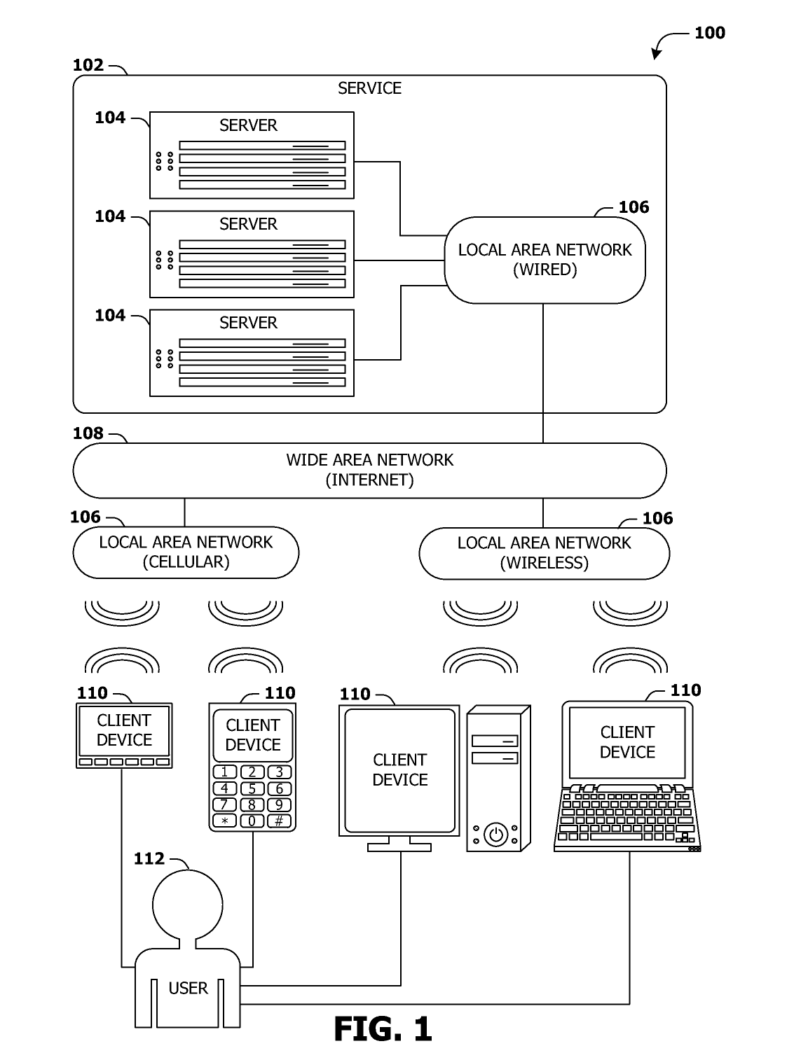

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may also be interconnected directly, or through one or more other networking devices, such as routers, switches, and repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may also include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and mesh architectures, and/or also a variety of roles, such as administrative servers, authentication servers, security monitor servers, data stores for objects such as files and databases, business logic servers, time synchronization servers, and front-end servers providing a user-facing interface to the service 102.

Likewise, a local area network 106 may comprise one or more sub-networks, such as may employ differing architectures or may be compliant or compatible with differing protocols, may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and client devices 110. The wide area network 108 may encompass various combinations of devices with varying levels of distribution and exposure, such as a public wide-area network (e.g., the Internet), or a private network (e.g., a virtual private network (VPN) of a distributed enterprise).

In the scenario 100 of FIG. 1, the service 102 may be accessed via the wide area network 108 by a user 112 of a set of client devices 110, such as a portable media player (e.g., an electronic text reader, an audio device, or a portable gaming, exercise, or navigation device); a portable communication device (e.g., a camera, a phone, or a text chatting device); a workstation; and a laptop form factor computer. The respective client devices 110 may communicate with the service 102 via various connections to the wide area network 108. As a first such example, one or more client devices 110 may comprise a cellular communicator, and may connect to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

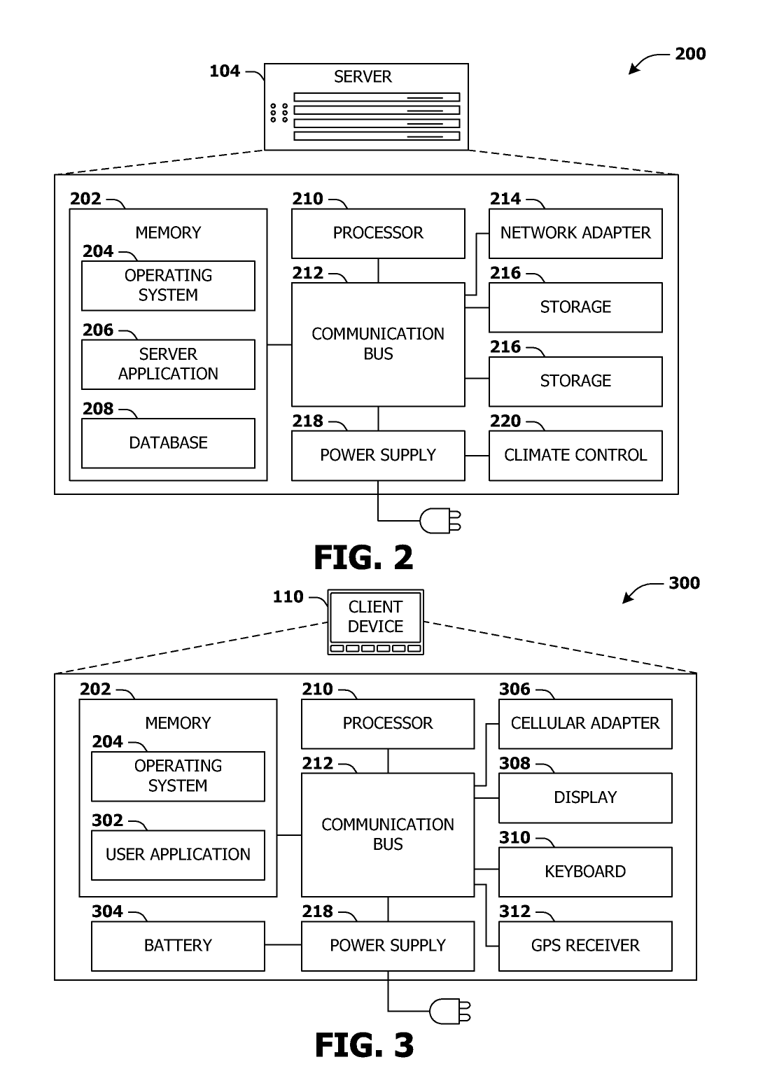

FIG. 2 presents a schematic architecture diagram 200 of a server 104 that may utilize at least a portion of the techniques provided herein. Such servers 104 may vary widely in configuration or capabilities, alone or in conjunction with other servers 104, in order to provide a service 102.

A server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. A server 104 may also comprise a memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may also comprise a variety of peripheral components, such as a wired and/or wireless network adapter 214 connectible to a local area network 106 and/or wide area network 108; one or more storage components 216, such as a hard disk drive, a solid-state storage device (SSD), a flash memory device, and/or a magnetic and/or optical disk reader. The server 104 may also comprise a mainboard featuring one or more communication buses 212 that interconnect the processor 210, the memory 202, and various peripherals, using a variety of bus technologies, such as a variant of a serial or parallel AT Attachment (ATA) bus protocol; the Uniform Serial Bus (USB) protocol; and the Small Computer System Interface (SCI) bus protocol. In a multibus scenario, a communication bus 212 may interconnect the server 104 with at least one other server 104. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

A server 104 may also operate in various physical enclosures, such as a desktop or tower, and/or may be integrated with a display as an “all-in-one” device. A server 104 may also be mounted horizontally and/or in a cabinet or rack, and/or may simply comprise an interconnected set of components. A server 104 may also comprise a dedicated and/or shared power supply 218 that supplies and regulates power for the other components. The server 104 may also provide power to and/or receive power from another server 104 and/or other devices. The server 104 may also comprise a shared and/or dedicated climate control unit 220 that regulates climate properties, such as temperature, humidity, and airflow. Many such servers 104 may be configured and/or adapted to utilize at least a portion of the techniques presented herein.

1.3. Client Device Configuration

FIG. 3 presents a schematic architecture diagram 300 of a client device 110 operable by a user 112, whereupon at least a portion of the techniques presented herein may be implemented. Such client devices 110 may vary widely in configuration or capabilities, in order to provide a variety of functionality to the user 112. A client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and a component of a piece of furniture, such as a tabletop, and/or of another device, such as a vehicle or residence. A client device 110 may also serve the user 112 in a variety of roles, such as a workstation, kiosk, media player, gaming device, and/or appliance.

A client device 110 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. A client device 110 may also comprise a memory 202 storing various forms of applications, such as an operating system 204; one or more user applications 302, such as document applications, media applications, file and data access applications, communication applications such as web browsers and email clients, utilities, and games; and drivers for various peripherals. A client device 110 may also comprise a variety of peripheral components, such as a wired and/or wireless network adapter 214 connectible to a local area network 106 and/or wide area network 108; one or more output components, such as a display 308 coupled with a display adapter (optionally including a graphical processing unit (GPU)), a sound adapter coupled with a speaker, and a printer; input devices for receiving input from the user 112, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, and/or an compass, accelerometer, and/or gyroscope that detects a physical orientation of the client device 110. Other components that may optionally be included with the client device 110 (though not shown in the schematic diagram 300 of FIG. 3) include one or more storage components 216, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

A client device 110 may also comprise a mainboard featuring one or more communication buses 212 that interconnect the processor 210, the memory 202, and various peripherals, using a variety of bus technologies, such as a variant of a serial or parallel AT Attachment (ATA) bus protocol; the Uniform Serial Bus (USB) protocol; and the Small Computer System Interface (SCI) bus protocol. A client device 110 may also comprise a dedicated and/or shared power supply 218 that supplies and regulates power for the other components, and/or a battery 304 that stores power for use while the client device 110 is not connected to a power source via the power supply 218. The client device 110 may also provide power to and/or receive power from other client devices 110.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user 112 via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may also include one or more servers that may locally serve the client device 110 and/or other client devices 110 of the user 112 and other individuals. For example, a locally installed webserver may provide web content in response to locally submitted web requests. Many such client devices 110 may be configured and/or adapted to utilize at least a portion of the techniques presented herein.

1.4. Search Engine and Service

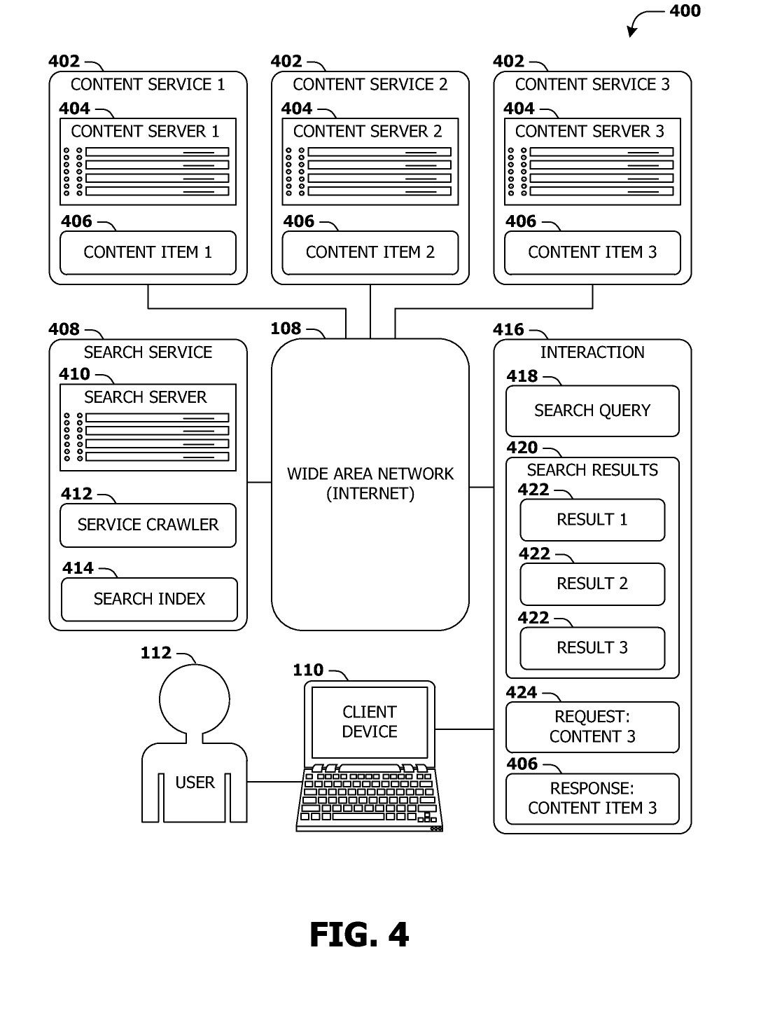

FIG. 4 is an interaction diagram of a scenario 400 a search engine or service that provides search results in response to a search query 418 on behalf of a user 112 and/or a client device 110. In this scenario 400, a set of content services 402 respectively comprise a content server 404 that provides access to a set of content items 406, such as text articles, pictures, video, audio, applications, data files, and output from devices such as cameras. A search service 408 is provided, comprising a search server 410 that interacts with the content services 402 over a wide area network 108, such as the Internet, to index the content items 406 provided thereby. For example, the search server 412 may utilize a service crawler 412 that iteratively explores the content services 402 and generates a search index 414 correlating the content items 406 of respective services 402 with various aspects, such as the name, logical address, object type, involved topics, and the producer and/or owner of the content item 406. The search service 408 may be deployed in a distributed manner across at least two search servers 410, which may be organized by role (e.g., a first search server 410 maintaining the search index 414, and a second search server 410 interacting with users 112 and/or client devices 110) and/or geographically (e.g., various search servers 410 may be provided to service client devices 110 in different physical locations). Components may be duplicated within the search service 408; e.g., two or more search servers 410 may be provided to facilitate the reliability, response time, and/or scalability of the search service 408.

As further illustrated in the scenario 400 of FIG. 4, a user 112 of a client device 110 may engage in an interaction 416 with the search service 408 and/or content services 402 in the following manner. For example, the client device 110 may present to the user 112 a search interface, such as a numeric and/or text entry field, a search command line, and/or a prompt to enter an audio command. The search interface may be depicted in many ways, such as with various types of labels (e.g., “Search,” “Submit,” or “Next”) and/or with a second control that may be activated to submit the search query 418 to the search service 408 (e.g., a button labeled “Search.” “Submit,” or “Next”). In some embodiments, the search interface may also be used to enter information other than a search query 418; e.g., a textbox may be provided that allows the user 112 either to specify a search query 418, or to specify an email address for correspondence with the user 112.

The user 112 may submit a search query 418, such as a set of search terms, to the search service 408. The search server 410 may compare the search query 418 with the search index 414 to identify a search result set 420, comprising a set of search results 442 that respectively identify an item of content item 406 stored by a content service 402. The search service 408 may send the search result set 420 back to the client device 110 in fulfillment of the search query 418, and the client device 110 may present the search result set 420 to the user 112. The search service 408 may comprise the provider of the search interface (e.g., the website for a search service 408 may provide a first web page featuring the search interface, and also a second web page providing the search results), and/or may be different than the provider of the search interface (e.g., a web page provided by a first search service 408 may forward the search query 418 to a second search service 408, which may send the search results 422 to the user 112. The search results 422 of the search result set 420 may also be sorted and/or ranked by relevance to the search query 418, by chronology, and/or by content service 402. If the user 112 selects a search result 422, the client device 110 may submit a request 424 for the content item 406 associated with the selected search result 422 to the consent service 402 storing the content item 406. The content server 404 may provide the content item 406 in response to the request 424, and the client device 110 may then present the selected content item 406 to the user 112. The search service 408 may also utilize other techniques and/or components, such as an index storage component, a search component, a ranking component, a cache, a profile storage component, a logon component, a profile builder, and one or more application program interfaces (APIs). Many such search services 408 may be provided, and may variously utilize the techniques presented herein.

In techniques such as those presented herein, search services 408 may index content provided by the same search service 408 (e.g., a search service 408 for a locally stored file system, database, or content library); for content stored by other content services 402; and/or for content stored by one or more client devices 110 (e.g., a cloud indexing service that indicates the availability of data objects on a distributed set of client devices 110 of the user 112). Additionally, such search services 408 may index a variety of content, including messages generated by and/or sent to the user 112; text articles; fiction and/or nonfiction stories; facts about topics such as individuals, companies, place; pictures; audio and video recordings; applications; data objects such as files and databases; and products or services.

Search services 408 may receive and process many types of search queries 418 specified in a variety of modalities, including text, handwriting, speech, verbal cues or keywords, gestures, and body language. The search queries 418 may also be specified in a variety of organizational formats, such as a group of keywords, a Boolean logical structure or expression tree, or a natural-language speech. Additionally, the search service 408 may return search results 422 that correlate with content items 406 in various ways, such as a hyperlink to a uniform resource identifier (URI) of the content item 406; a description of the content item 406, such as the title, file type, generation date, synopsis, and/or preview version of the content item 406; and/or a copy of the full content item 406. The search results 422 may also be presented to the user 112 in many ways, such as in the same presentation as a search interface (e.g., presented in the same web page as the search interface, as in above, below, aside, or in place of the search interface); in a second presentation that is distinct from but related to the search interface (e.g., presented in a second web page or popup window); and/or in a second presentation that is unrelated to the search interface, such as a separate application (e.g., receiving a search query 418 through a web browser and presenting the search results 422 in a second application) and/or a different modality as the search interface (e.g., receiving a search query 418 provided in a web page, and presenting to the user 112 an audially presented set of search results 422).

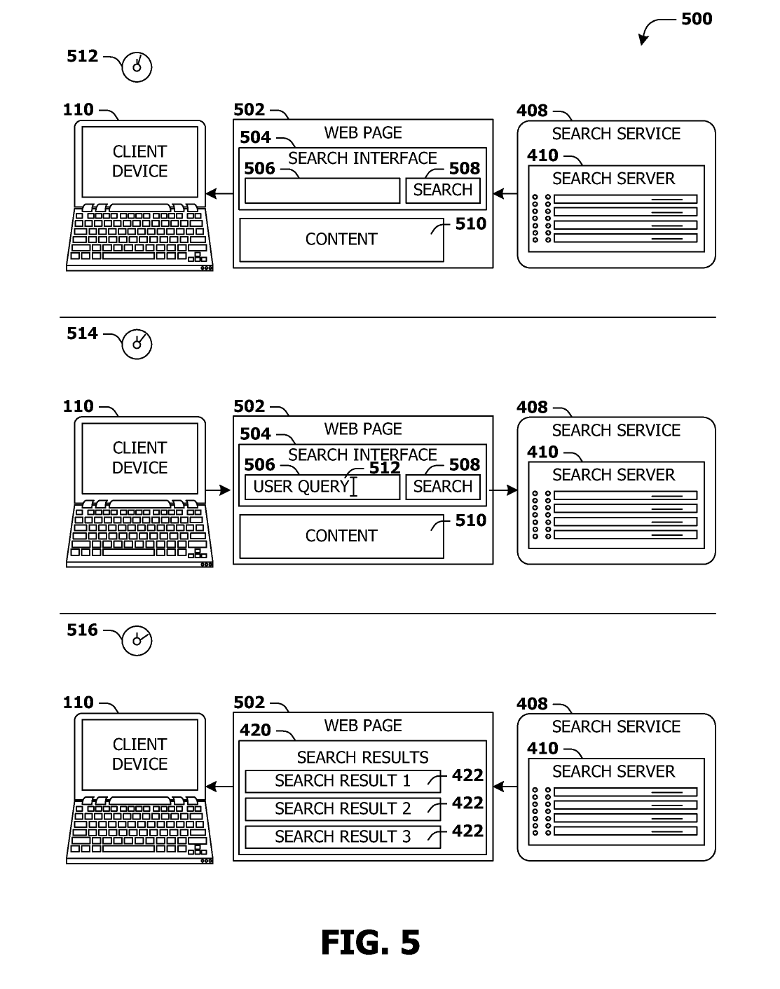

FIG. 5 is an interaction diagram of a scenario 500 involving the interaction 416 of the user 112 with the search service 408 and/or a content service 402. In this scenario 500, at a first time 512, a search server 410 of a search service 408 sends to a client device 110 a web page 502 presented within a web browser and including content 510, such as an informational article, a picture, an audio and/or video recording, and/or an application such as a game. The web page 502 also comprises a search interface 504, such as a textbox 506 and a submit button 508 that are initially empty at the first time 512. At a second time 514, the user 112 of the client device 110 enters a user-initiated search query 512 into the textbox 506 of the search interface 504, and may activate the submit button 508 to submit the user-initiated search query 512 to the search service 408. The search server 410 may receive the user-initiated search query 512 and generate a search result set 420, comprising at least one search result 422 that describes a content item 406 matching the user-initiated search query 512. At a third time 516, the search service 408 may return the search result set 420 to the client device 110, which may present the search results 422 to the user 112 (e.g., updating the web page 502 to replace the content 510 with the search result set 420). In this manner, the search service 408 and the client device 110 may interoperate to allow the user 112 to fulfill user-initiated search queries 512 submitted by the user 112 to the search service 408.

### 2. PRESENTED TECHNIQUES

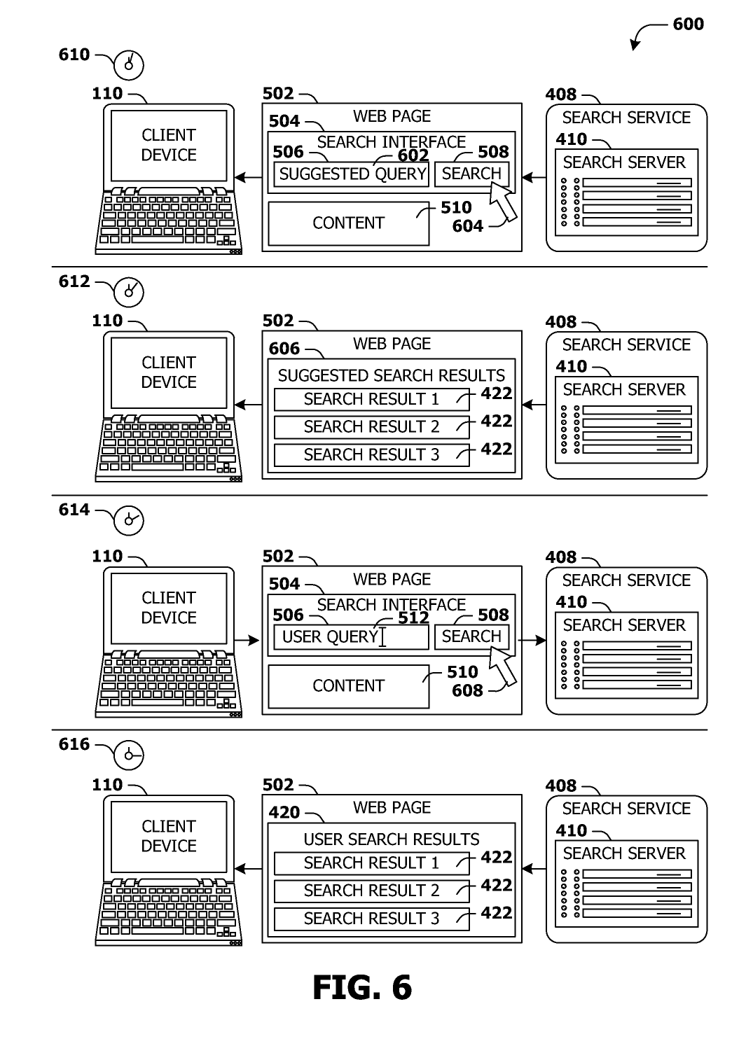

FIG. 6 is an illustration of a scenario 600 involving another technique for enabling a search service 408 to present search results 422 to a user 112 of a client device 110. In this scenario 600, at a first time 610, a search service 408 provides a web page 502 to the client device 110 that includes a search interface 504, such as a textbox 504 and a submit button 508, in addition to content 510, such as an informational article, a picture, an audio and/or video recording, and/or an application such as a game. The search interface 504 is configured to receive a user-initiated query 512 for submission to the search service 408. However, at this first time 610, before receiving a user-initiated search query 512 from the user 112, the search service 408 identifies a suggested search query 602 that is of predicted interest to the user 112. For example, the suggested search query 602 may comprise a frequently submitted user-initiated search query 512 that other users 112 have recently submitted; a search query about a topic for which the user 112 has previously expressed an interest; or a search query that is related to the content 510 of the web page 502. The search service 408 may send the web page 502 to the client device 110 with the search interface 504 preloaded with the suggested search query 602. The client device 110 may therefore present the web page 502 to the user 112 with the search interface 504 preloaded with the suggested search query 602 (e.g., showing a set of keywords in the textbox 506 that indicate the nature of the suggested search query 602). If the user 112 initiates a selection 604 of the suggested search query 602 (e.g., a selection of the submit button 508 while not having modified the textbox 506 of the search interface 504 to enter a user-initiated search query 512), then at a second time 612, the search service 408 may present to the user 112 suggested search result set 606 of the suggested search query 602 to the client device 110, and the client device 110 may present the suggested search result set 606 to the user 112. Alternatively, at a third time 614, if the user 112 chooses not to perform a selection 604 of the suggested search query 602 but initiates a user-initiated search query 512 in the search interface 504 (e.g., selecting and typing in the textbox 506 and performing a selection 508 of the submit button 508), then at a fourth time 616, the search service 408 may return a user-initiated search result set 420, and the client device 110 may present the user-initiated search result set 420 to the user 112. In either scenario, a selection by the user 112 of a search result 442 causes the client device 110 to retrieve the content item 406 described by the search result 422, and to present the content item 406 in the web page 502.

### 3. TECHNICAL EFFECT

The techniques presented herein and illustrated in the scenario 600 of FIG. 6 may provide a variety of technical effects for the client device 110 and/or the search server 410.

As a first technical effect, by preloading the search interface 504 with a suggested search query 602, the client device 112 and/or search service 408 may make use of a control in a web page 502 or other document that is initially empty.

As a second technical effect, by preloading the search interface 504 with a suggested search query 602, the client device 112 and/or search service 408 may assist a user 112 who has difficulty using the search interface 504. As a first such example, a client device 110 such as a mobile phone may conveniently respond to pointing input, including the selection 604 of the submit button 508 of a search interface 504, but may have more limited data entry capabilities, such as lacking a usable keyboard or providing a text entry interface that is cumbersome and potentially frustrating. The user 112 may therefore appreciate the preloading of the search interface 504 with a suggested search query 602 that enables the user 112 to avoid using the text entry interface. As a second such example, a disabled user 112 may have difficulty entering information, and may appreciate a convenience of not having to enter a suggested search query 602 into the search interface 504.

As a third technical effect, by preloading the search interface 504, the client device 110 may guide the user 112 to new content 510 that the user 112 may not have otherwise discovered. As a first such example, the user 112 may not have known the correct spelling of a search term associated with a topic of interest to the user 112 (e.g., the correct spelling of an individual's name or of a place, or the name of a product or technology), and may therefore have had difficulty identifying a correct user-initiated search query 512. As a second such example, the user 112 may not have thought to initiate the user-submitted search query 512 for a particular topic, such as the topic of the content 510 of the web page 502, and the preloading of the search interface 504 with the suggested search topic 602 may guide the user 112 to additional content 510 of interest. As a third such example, the suggested search query 602 may present search results 442 from a content service 402 that was not previously known to the user 112, and the preloading of the search interface 504 may enable the user 112 to discover new content services 402. These and other technical effects maybe achievable through the configuration of the client device 110 and/or the search server 410 to implement the techniques presented herein.

### 4. EXEMPLARY EMBODIMENTS

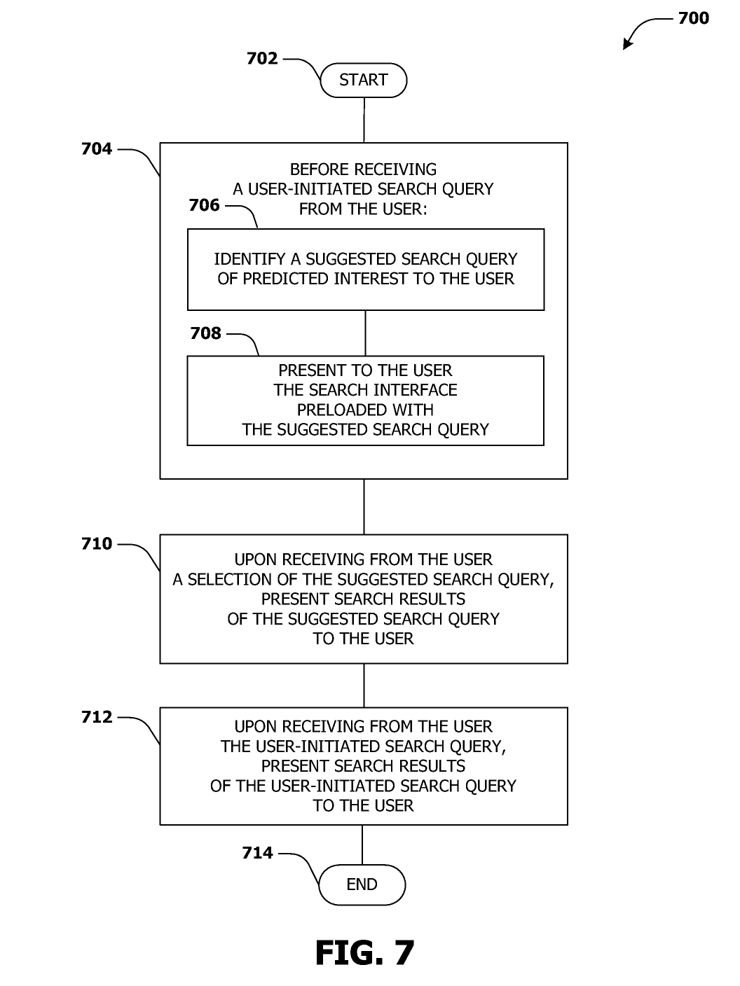

FIG. 7 presents an illustration of a first exemplary embodiment of the techniques presented herein, illustrated as an exemplary method 700 of presenting a search interface 504 to a user 112. The exemplary method 700 may be implemented, e.g., as instructions stored in a memory (e.g., a hard disk drive, a solid-state storage device such as a flash memory device, or a magnetic or optical disc) that, when executed on a processor 210 of a computer such as a client device 112 and/or a server 104, cause the computer to operate according to at least a portion of the techniques presented herein. The exemplary method 700 begins at 702 and comprises, before receiving 704 a user-initiated search query 512 from the user 112, identifying 706 a suggested search query 602 that is of predicted interest to the user 112, and presenting 708 to the user 112 the search interface 504 preloaded with the suggested search query 602. The exemplary method 700 also comprises, upon receiving from the user 112 a selection 604 of the suggested search query 602, presenting 710 search results 422 of the suggested search query 602 to the user 112. The exemplary method 700 also comprises, upon receiving the user-initiated search query 512 from the user 112, presenting 712 search results 422 of the user-initiated search query 512 to the user 112. In this manner, the exemplary method 700 achieves the presentation of the search interface 504 to the user 112, and so ends at 714.

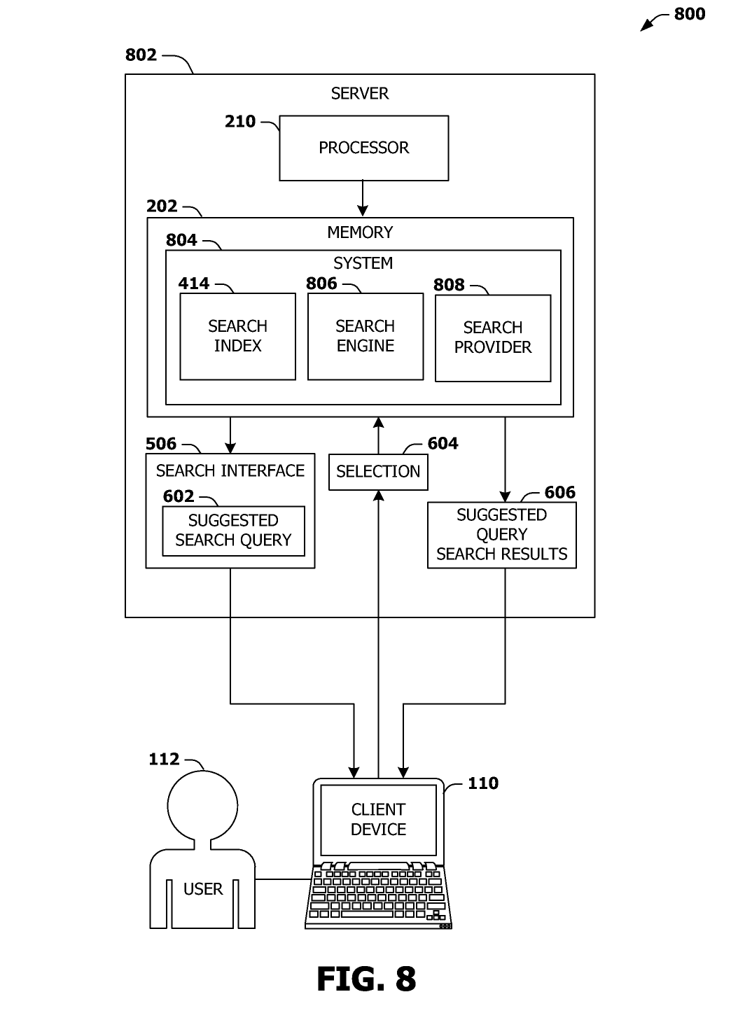

FIG. 8 presents an illustration of a scenario 800 involving a second exemplary embodiment of the techniques presented herein, comprising a server 802 that provides a search interface 504 to a user 112. The server 802 may comprise a processor 210, and a memory (e.g., a hard disk drive, a solid-state storage device such as a flash memory device, or a magnetic or optical disc) storing instructions that together comprise the components of an exemplary system 804 that causes the server 802 to present a search interface 504 to a user 112 of a client device 110. In particular, the exemplary system 804 comprises a search index 414 indexing the content items 406 of respective services 402. The exemplary system 804 also comprises a search engine 806 that processes a search query submitted by the user 112 of the client device 110. The exemplary system 804 also comprises a search provider 808 that utilizes the search index 414 and the search engine 806 to provide a search interface 504 in accordance with the techniques presented herein. In particular, the search provider 808, before receiving a user-initiated search query 512 from the user 112, identifies a suggested search query 602 that is of predicted interest to the user 112, and presents to the user 112 the search interface 504 preloaded with the suggested search query 602 (e.g., as a textbox 506 of a web page 502 that is preloaded with the suggested search query 602). The search provider 808 also, upon receiving from the user 112 a selection 604 of the suggested search query 602, presents search results 606 of the suggested search query 602 to the user 112 (e.g., by invoking the search engine 806 to parse the suggested search query 604, which in turn identifies search results 422 according to the search index 414, and by providing a web page 502 featuring the search results 422 of the suggested search query 602). The search provider also, upon receiving the user-initiated search query 512 from the user 112, present search results 422 of the user-initiated search query 512 to the user 112 (e.g., by invoking the search engine 806 to parse the user-initiated search query 512, which in turn identifies search results 422 according to the search index 414, and by providing a web page 502 featuring the search results 422 of the user-initiated search query 512). In this manner, the server 802 in the scenario 800 of FIG. 8 presents a search interface 504 to a user 112 in accordance with the techniques presented herein.

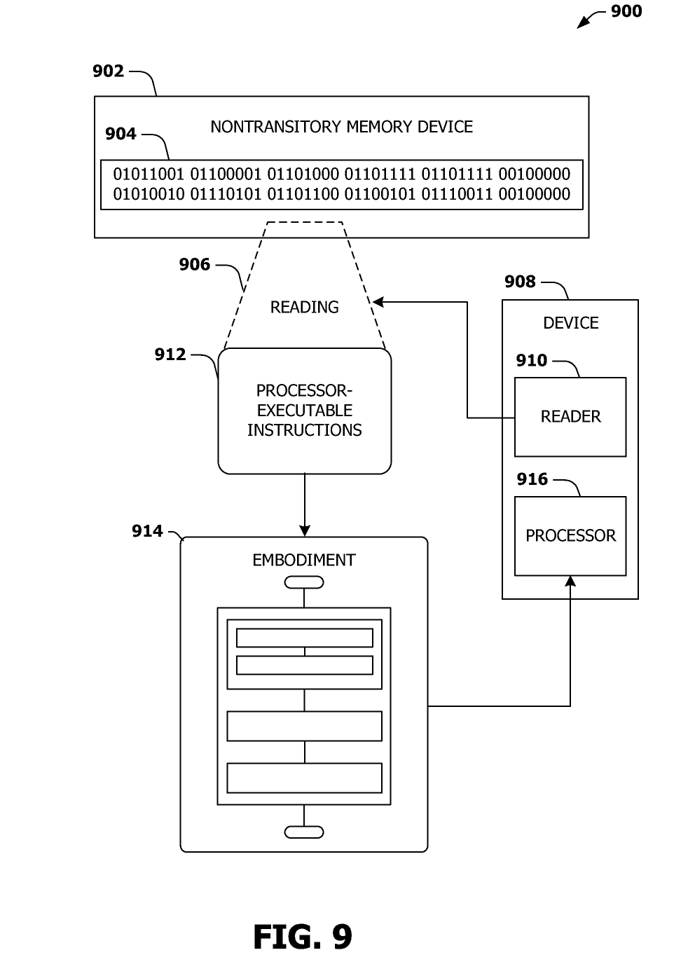

FIG. 9 is an illustration of a scenario 900 involving a third exemplary embodiment of the techniques presented herein, comprising an exemplary nontransitory memory device 902, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The exemplary nontransitory memory device 902 stores computer-readable data 904 that, when subjected to reading 906 by a reader 901 of a device 908 (e.g., a read head of a hard disk drive, or a read operation invoked on a solid-state storage device), express processor-executable instructions 912. The processor-executable instructions 912, when executed on a processor 916 of the device 908, cause the device 908 to present a search interface 504 to a user 112. In particular, the processor-executable instructions 912 cause the device 908 to, before receiving a user-initiated search query 512 from the user 112, identify a suggested search query 602 that is of predicted interest to the user 112, and present to the user 112 the search interface 504 preloaded with the suggested search query 602. The execution of the processor-executable instructions 912 on the processor 916 also causes the device 908 to, upon receiving from the user a selection of the suggested search query 602, present search results 422 of the suggested search query 602 to the user 112. The execution of the processor-executable instructions 912 on the processor 916 also causes the device 908 to, upon receiving the user-initiated search query 512 from the user 112, present search results 422 of the user-initiated search query 512 to the user 112. In this manner, the exemplary nontransitory memory device 902 causes the device 908 to present the search interface 504 to the user 112 in accordance with the techniques presented herein.

### 5. VARIATIONS

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 700 of FIG. 7; the exemplary system 804 of FIG. 8; and the exemplary nontransitory memory device 902 of FIG. 9) to confer individual and/or synergistic advantages upon such embodiments.

5.1. Selecting Suggested Search Query

A first aspect that may vary among embodiments of the presented techniques involves the selection of a suggested search query 602 that is of predicted interest to the user 112.

As a first variation of this first aspect, the suggested search query 602 may be selected by identifying a popular search query that is frequently submitted by users 112 of the search interface 504. For example, users 112 may be frequently submitting a search query with the name of a popular musical artist, movie, or product. A search engine 806 may be able to identify the search queries having a high frequency among the users 112, and the search interface 504 may be preloaded with the popular search query as the suggested search query 602.

As a second variation of this first aspect, the suggested search query 602 may be selected as a positively trending search query that involves a positively trending search topic. For example, two well-known musical artists may be popular search topics in the search engine 806, but the first musical artist may be of renewed interest due to the release of a news story. A search engine 806 may be able to identify positive trends among such search topics, and the search interface 504 may be preloaded with the positively trending search topic as the suggested search query 806.

As a third variation of this first aspect, the suggested search query 602 may be selected as a topical suggested search query, involving a topic that is of predicted interest to the user 112 according to a user profile. For example, the user profile of the user 112 may indicate a variety of topics that are of interest to the user 112, e.g., generated from an explicit selection or declaration of interests of the user 112, and/or inferences based on the actions of the user 112, such as the user's purchasing history, or the duration of engagement of the user 112 with various content, such as the amount of time that the user 112 spends reading an article about a topic. A search engine 806 may be able to identify or generate one or more search queries 418, and the search interface 504 may be preloaded with the suggested search query 602 involving one or more topics of interest to the user 112.

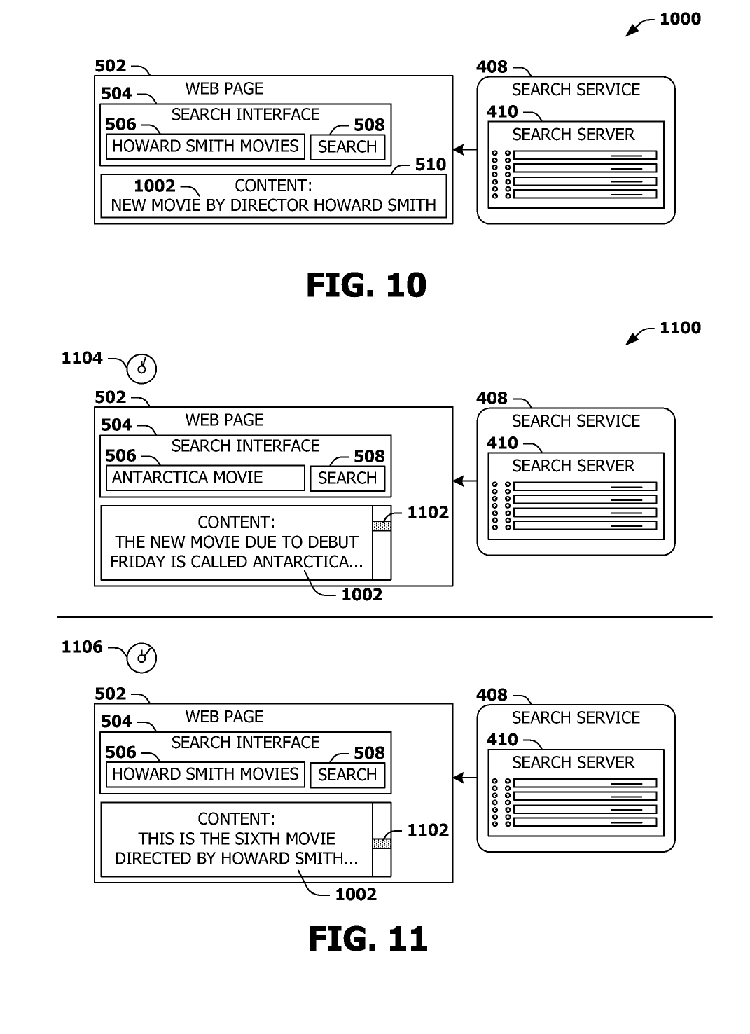

FIG. 10 is an illustration of a scenario 1000 presenting a fourth variation of this first aspect. In this scenario 1000, the search interface 504 is presented in a web page 502 in conjunction with content 510 including a presented topic 1002, such as a news article about a movie by a particular director. The search server 410 may detect the presented topic 1002 in the content 510, and may identify or generate a topical search query 602 that is associated with the presented topic 1002, such as keywords that identify the presented topic 1002 and that, if selected by the user 112, cause the search service 408 to present search results 422 that provide more information about the presented topic 1002. The search service 408 may then present to the user 112 the search interface 504 preloaded with the topical search query as the suggested search query 602.

As a fifth variation of this first aspect, the suggested search query 602 may be selected as a topical search query that users 112 frequently submit after viewing the content 510. For example, the topical search query 602 may comprise a search query 18 that users 112 frequently submit after viewing the content 510, which may represent questions that the content 510 prompts such users 112 to ask and to seek answers. The search service 408 may then present to the user 112 the search interface 504 preloaded with the topical search query as the suggested search query 602.

FIG. 11 is an illustration of a scenario 1100 presenting a sixth variation of this first aspect. In this scenario 1100, the search service 408 again provides the search interface 504 in a web page 502 in conjunction with content 510. However, the search interface 504 tracks a viewed portion of the content 510, and preloads the search interface 504 with suggested search queries 602 involving the presented topics 1002 in the viewed portion of the content 510. For example, at a first time 1104, the search service 408 may identify a first scroll position 1102 selected by the user 112 within the content 510, and a first presented topic 1002 positioned within the content 510 at the first scroll position 1102. Accordingly, the search interface 504 may be preloaded with a first suggested search query 602 involving the first presented topic 1002. At a second time 1106, the search service 408 may identify a second scroll position 1102 selected by the user 112 within the content 510, and a second presented topic 1002 positioned within the content 510 at the second scroll position 1102. Accordingly, the search interface 504 may replace the first suggested search query 602 with a second suggested search query 602 involving the second presented topic 1002. In this manner, the search service 408 may update the preloading of the search interface 504 to reflect the presented topics 1002 in the content 510.

As a seventh variation of this first aspect, the search interface 504 may limit the presentation of suggested search queries 602 to those that are of comparatively high predicted interest to the user 112. For example, the search service 408 may calculate a predicted user interest score of the suggested search query 602 to the user 112, and may provide the suggested search query 602 for presentation by the search interface 504 only if the predicted user interest score of the suggested search query 602 exceeds a predicted user interest threshold.

As an eighth variation of this first aspect, the suggested search query 602 may return a similar type of search result set 420 as a user-initiated search query 512. Alternatively, the suggested search query 602 may return a different type of search result set 420 as a user-initiated search query 512. As a first such example, the suggested search query 602 may return search results 422 involving a particular type of content, such as music items, and/or involving a particular topic, while the user-initiated search query 512 may provide search results 422 for a general-purpose web search. As a second such example, the suggested search query 602 may return a single, specific search result 422, such as a particular article, while the user-initiated search query 512 may provide a broader number of search results 422 in furtherance of user selection.

As a ninth variation of this first aspect, the suggested search query 602 may be selected to promote the interests of the search service 408. As a first such example, the suggested search query 602 may be selected that, upon selection by the user 112, highlights a new feature or capability of the search service 408. As a second such example, the suggested search query 602 may produce results that promote traffic through the search service 408, e.g., preferentially selecting search results 422 provided by the search service 408 over search results 422 provided by other content sources. As a third such example, the suggested search query 602 may be selected that promotes advertising and/or sales revenue of the search service 408, e.g., preferentially selecting search results 422 for products sold by the search service 408 and/or by advertisers that sponsor the search service 408. Many such variations in the selection of suggested search queries 602 may be included in embodiments of the techniques presented herein.

5.2. Presenting Search Interface

A second aspect that may vary among embodiments of the presented techniques involves the presentation of the search interface 504 preloaded with the suggested search query 602.

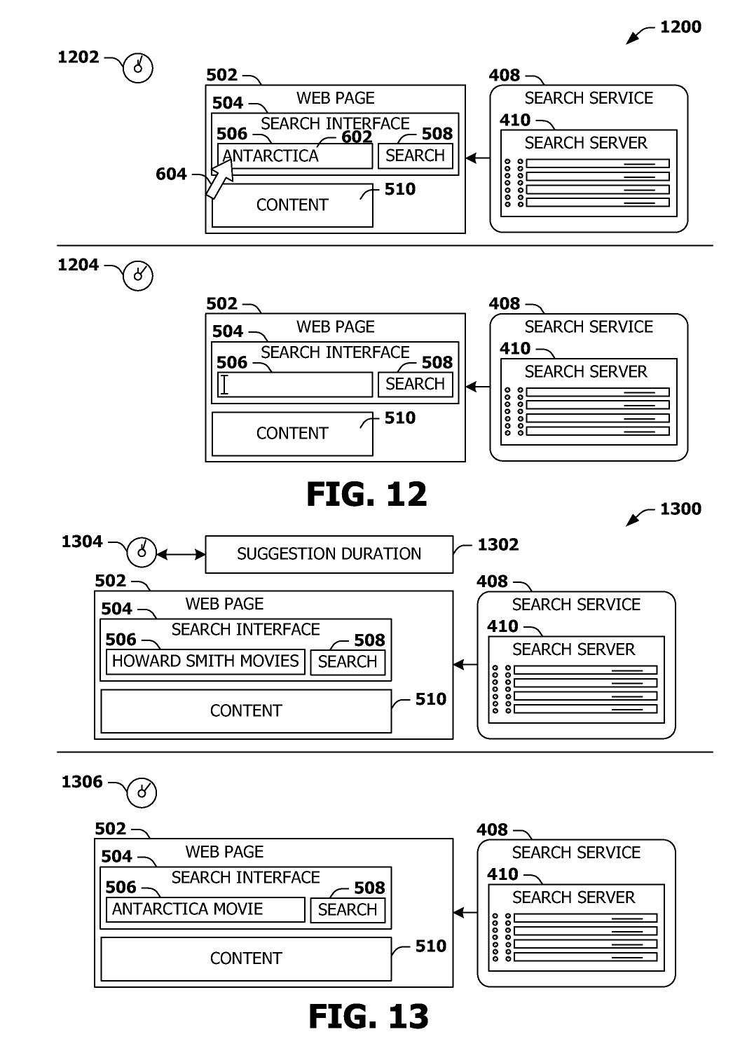

FIG. 12 is an illustration of a scenario 1200 presenting a first variation of this second aspect. In this scenario 1200, at a first time 1202, before receiving from the user 112 an interaction with the search interface 504, the search service 408 may present the search interface 504 including a suggested search query 602. If the user 112 initiates a selection 604 of the suggested search query 602 (e.g., clicking on the submit button 508), the search service 408 may present the search results 422 of the suggested search query 602 to the user 112. However, if the user 112 performs a selection 604 of the search interface 504 in order to enter a user-initiated search query 512, the client device 110 and/or search service 408 may construe such selection 604 as a refusal by the user 112 of the suggested search query 602. Accordingly, the suggested search query 602 may be removed from the search interface 504 (e.g., erasing the content of a textbox 506 of the search interface 504, and positioning a text entry cursor at the start of the textbox 506), in order to facilitate the entry of the user-initiated search query 512 by the user 112. In an alternative embodiment (not shown), the selection 604 of the search interface 504 may enable the user 112 to select and/or modify the suggested search query 602, e.g., by appending additional keywords.

As a second variation of this second aspect, the search service 408 may identify at least two suggested search queries 602 that are of predicted interest to the user 112, and preload the search interface 504 with the set of suggested search queries 602. As a first such example, the search interface 504 may be provided, e.g., as a drop-down list of suggested search queries 602, and the user 112 may select any entry from the list. As a second such example, the search interface 504 may rotate through the respective suggested search queries 602 provided by the search service 408.

FIG. 13 is an illustration of a scenario 1300 providing another example of this second variation of this second aspect, involving a suggestion duration 1302. At a first time 1304, the search interface 504 presents a first suggested search query 602. If the user 112 selects the first suggested search query 504, the search interface 504 may present the search results 422 of the first suggested search query 504. However, if the user 112 does not select the first suggested search query 602 within a suggestion duration 1302, then at a second time 1306, the search interface 504 replaces the first suggested search query 504 with a second suggested search query 504. In this manner, the search interface 504 may rotate through a set of such suggested search queries 602 to the user 112.

As a third variation of this second aspect, the search interface 504 may use different visual styles for suggested search queries 602 and user-initiated search queries 512 in order to connote the source of the respective search queries. For example, the search interface 504 is preloaded with the suggested search query 602, the search interface 504 may use a first visual style, such as a first font, a first color, or a first shading. Upon receiving the user-initiated search query 512 from the user 112, the search interface 504 may present the user-initiated search query 512 with a second visual style that is different from the first visual style. As another such variation, the search interface 504 may display a description of the search results 422 returned by the suggested search query 602 (e.g., when presenting a suggested search query 602 involving a search for music by a particular artist, the search interface 504 may be labeled as “find music by this artist”).

As a fourth variation of this second aspect, the search interface 504 may respond in various ways when the user 112 selects a suggested search query 602 and/or a user-initiated search query 512. As a first such example, upon receiving either such selection from the user 112 while the search interface 504 is presented adjacent to content 510 such as a web page 502, the search interface 504 may replace the content 510 with the search result set 420. As a second such example, upon receiving either such selection from the user 112, the search interface 504 may present the search result set 420 adjacent to the content 510 and without altering the content 510, such as in a peripheral portion of the web page 502.

As a fifth variation of this second aspect, even before the user 112 selects a suggested search result 602, the search service 408 may identify the search results 422 for the suggested search result 602. The search results 422 may be held ready in case the user 112 selects the suggested search result 602, either by the search service 408 or by the client device 110, such that when the user 112 selects the suggested search result 602, the search results 422 may be promptly provided.

As a sixth variation of this second aspect, upon selection of the suggested search query 602 by the user 112, the search interface 504 may submit a suggested search query 602 to a selected search engine. As a first such example, a search service 408 may be associated with the suggested search query 602, and the search interface 504 may accordingly submit the suggested search query 602 to the associated search engine as indicated by the search service 408. For example, the associated search engine may be selected, e.g., according to a type of topic in the suggested search query 602 (e.g., when providing a suggested search query 602 for a movie, the search service 408 may indicate that the suggested search query 602 is to be submitted to a movie information database); according to a media type of the suggested search query 602 (e.g., when providing a suggested search query 602 for selected video recordings, the search service 408 may indicate that the suggested search query 602 is to be submitted to a database of videos that the user 112 may view); and/or according to a user-selected search engine (e.g., a search engine that has been selected by the user 112). Alternatively or additionally, the user 112 may specify a restriction of a search engine that is not to be used. Such preferences may be recorded in a user profile of the user 112, and the search interface 504 presented to the user 112 may be configured to fulfill the preferences of the user 112. Many such variations of the presentation of the search interface 504 may be included in embodiments of the techniques presented herein.

### 6. USAGE OF TERMS

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A method of presenting a search interface to a user, comprising:
before receiving a user-initiated search query from the user:
identifying a suggested search query that is of predicted interest to the user, and
presenting to the user the search interface preloaded with the suggested search query;
upon receiving from the user a selection of the suggested search query, presenting search results of the suggested search query to the user; and
upon receiving the user-initiated search query from the user, presenting search results of the user-initiated search query to the user.

2. The method of claim 1, wherein identifying the suggested search query further comprises: identifying, as the suggested search query, a popular search query that is frequently submitted by users of the search interface.

3. The method of claim 1, wherein identifying the suggested search query further comprises: identifying, as the suggested search query, a positively trending search query that involves a positively trending search topic.

4. The method of claim 1, wherein:
the user is associated with a user profile; and
identifying the suggested search query further comprises: identifying a topical suggested search query that is related to a topic of predicted interest to the user according to the user profile of the user.

5. The method of claim 1, wherein:
the search interface is presented in conjunction with content including a presented topic; and
identifying the suggested search query further comprises: identifying, as the suggested search query, a topical search query that is associated with the presented topic.

6. The method of claim 1, wherein:
the search interface is presented in conjunction with content; and
identifying the suggested search query further comprises: identifying, as the suggested search query, a topical search query that is frequently submitted by users after viewing the content.

7. The method of claim 5, further comprising:
while the user views the content:
identify a viewed portion of the content; and
identify the presented topic within the viewed portion of the content.

8. A server providing a search interface to a user, comprising:
a processor; and
a memory storing instructions that, when executed on the processor, cause the server to:
before receiving a user-initiated search query from the user:
identify a suggested search query that is of predicted interest to the user, and
present to the user the search interface preloaded with the suggested search query;
upon receiving from the user a selection of the suggested search query, present search results of the suggested search query to the user; and
upon receiving the user-initiated search query from the user, present search results of the user-initiated search query to the user.

9. The server of claim 8, wherein executing the instructions on the processor further causes the server to, upon receiving from the user a selection of the search interface for entering the user-initiated search query, remove the suggested search query from the search interface.

10. The server of claim 8, wherein:
identifying the suggested search query further comprises: identifying at least two suggested search queries that are of predicted interest to the user; and
presenting the search interface further comprises: presenting the search interface preloaded with a selected suggested search query among the at least two suggested search queries.

11. The server of claim 10, wherein presenting the search interface further comprises:
at a first time before receiving the user-initiated search query, presenting the search interface preloaded with a first suggested search query among the at least two suggested search queries; and
at a second time before receiving the user-initiated search query that is different from the first time, presenting the search interface preloaded with a second suggested search query among the at least two suggested search queries that is different from the first suggested search query.

12. The server of claim 11, wherein:
the server defines a suggested search query presentation period; and
presenting the second suggested search query further comprises: upon detecting that the user has not selected the first suggested search query within the search query presentation period, replace the first suggested search query in the search interface with the second suggested search query.

13. The server of claim 8, wherein:
presenting the suggested search query further comprises: presenting the search interface preloaded with the suggested search query in a first visual style; and
executing the instructions on the processor further causes the server to, upon receiving the user-initiated search query from the user, present to the user the search interface loaded with the user-initiated search query in a second visual style that is different from the first visual style.

14. The server of claim 8, wherein:
the search interface is presented adjacent to content;
presenting the search results of the suggested search query further comprises: presenting the search results adjacent to and without altering the content; and
presenting the search results of the user-initiated search query further comprises: presenting the search results adjacent to and without altering the content.

15. A nontransitory memory device storing instructions that, when executed on a processor of a server, cause the server to present a search interface to a user, by:
before receiving a user-initiated search query from the user:
identifying a suggested search query that is of predicted interest to the user, and
presenting to the user the search interface preloaded with the suggested search query;
upon receiving from the user a selection of the suggested search query, presenting search results of the suggested search query to the user; and
upon receiving the user-initiated search query from the user, presenting search results of the user-initiated search query to the user.

16. The nontransitory memory device of claim 15, wherein executing the instructions on the processor further causes the server to, before receiving from the user the selection of the suggested search query, identify the search results of the suggested search query.

17. The nontransitory memory device of claim 15, wherein:
identifying the suggested search query of predicted interest of the user further comprises: calculating a predicted user interest score of the suggested search query to the user; and
presenting the search interface further comprises: presenting to the user the search interface preloaded with the suggested search query only if the predicted user interest score of the suggested search query exceeds a predicted user interest threshold.

18. The nontransitory memory device of claim 15, wherein:
identifying the suggested search query further comprises: identifying a search engine that is associated with the suggested search query; and
presenting search results of the suggested search query further comprises: upon receiving from the user the selection of the suggested search query, identify at least one search result by submitting the suggested search query to the search engine that is associated with the suggested search query.

19. The nontransitory memory device of claim 18, wherein:
the suggested search query is associated with a media type; and
identifying the search engine further comprises: identifying a search engine associated with the media type of the suggested search query.

20. The nontransitory memory device of claim 15, wherein:
the user is associated with a user-selected search engine; and
presenting search results of the suggested search query further comprises: upon receiving from the user the selection of the suggested search query, identify at least one search result by submitting the suggested search query to the user-selected search engine.
